(19) United States
(12) Patent Application Publication
(10) Pub. No.: US 2017/0239129 A1
(43) Pub. Date: Aug. 24, 2017

(54) Clean Mate Mobility Aid Task Device

(71) Applicant: Geemay Chia, Gate Mills, OH (US)

(72) Inventor: Geemay Chia, Gate Mills, OH (US)

(21) Appl. No.: 15/050,202

(22) Filed: Feb. 22, 2016

(51) Int. Cl. A61H 3/04

(52) U.S. Cl. CPC A61H 3/04; A61H 2003/002

(57) ABSTRACT

A mobility aid task device comprises a mobility aid, one or more mobile storage disposed in the mobility aid, and a seat disposed in the mobile storage. The mobility aid comprises a crosspiece disposed in a first direction in the mobility aid, a plurality of vertical members including one or more front vertical members and one or more back vertical members wherein the front vertical member is coupled with the back vertical member in a second direction; and a plurality of rotatables coupled with the vertical member at a bottom of the vertical member. A first mobile storage comprises a storage container and a storage cover disposed in the storage container at a level about average standing adult hip height generally parallel to a ground and comprising a seat. Caddies may be fitted in the storage container and removably attached to fixed or removable attachments.

### CROSS-REFERENCE TO RELATED APPLICATION

This application claims the benefit of U.S. Provisional Application Ser. No. 62/134,618 filed on Mar. 18, 2015, which is herein incorporated by reference in its entirety for all purposes.

### BACKGROUND

House tasks such as cleaning and home repairs are necessary human activities to maintain a healthy living environment. House tasks are challenging because they require physical strength. The elderlies have difficulties with house tasks because of age-related deteriorations, such as diabetes, arthritis, and neuritis, etc. These conditions may cause stiff neck and back, weak arms and legs, and decreased motion in hands and wrists. Particularly, the elderlies have difficulties in maintaining balance due to pain (or numbness) in ankles, knees, back and hips. Reduced strength and insufficient balance limit the elderly's abilities in carrying tools and materials and performing house tasks. As the baby boomer generation ages, they still desire independent living. The ability to perform house tasks by themselves is part of independent living.

Many products have been created to assist elderlies in other areas of daily living, such as pill boxes for dispensing medicine, handicap bars for bathroom support, electrical toothbrushes for oral hygiene, or wheelchairs for movement inside or outside of a home. However, house task devices such as cleaning or home repair devices have not been created for the elderly. For example, the available cleaning carts are for commercial cleanings in an office setting. These carts are created for the general population. The carts are to be used by people of common physique with no consideration of age or physical limitations. For the reasons described above, the elderly and physically limited people have difficulties using the existing cleaning carts. Similarly, few house task devices are created to assist the elderly or physically limited people to perform house tasks such as home maintenance or repairs.

For the above discussed reasons, it is desirable to create a house task device for the elderly and physically limited people.

### SUMMARY

These embodiments generally relate to mobility aid task devices and methods of forming such devices. The embodiments simplify tasks such as cleaning or repairing for elderly, physically limited, and general population as well. The exemplary device, with its many variations, is simple, easy to use, light weight, and easily movable. Also, the device provides storage which is accessible from a standing position and reduces bending.

The device amalgamates the concepts of mobility aid, mobile storage and a seat. The mobility aid is embodied in a walker or similar devices such as carts, wheelchairs, transports, and so forth. Mobile storage is embodied in one or more storage disposed in the mobility aid, such as a storage container, a back bucket, fixed and removable attachments. A seat is embodied in a storage container or may be in other similar devices such as folding chairs, lawn chairs, and attachable/detachable stools. In operation, a user may push the mobility aid to a desired location using the mobility aid for balance while transporting supplies and tools in the mobility aid. At location, the user may sit on the seat using the mobility aid for support while performing tasks. The user may push the mobility aid to the next location for another task. When finished, the user may place the supplies and tools back into the mobile storage, fold the mobility aid task device, and store the device.

The mobility aid task device includes a main framework of a crosspiece, one or more front vertical members, one or more back vertical members, one or more mobility storage and a plurality of rotatables at the bottoms of the vertical members. The crosspiece provides a handle for pushing or pulling the mobility aid task device. Vertical members are coupled horizontally with the crosspiece providing vertical and horizontal supports of the mobility aid task device. A first mobility storage includes a storage container having a storage cover generally parallel to the floor or ground which provides a seat. The storage container also provides one or more storage compartments. Rotatables at the bottom of vertical members provide wheel mechanisms for moving the mobility aid task device.

A support framework is installed in the main framework, including support rods, wire frames, etc. Fixed or removable attachments are installed in the main or support framework. Fixed attachments include, but are not limited to, top attachments such as top hooks, side attachments such as side hangers, and bottom attachments such as bottom clips. Removable attachments include, but are not limited to, caddies or receptacles. In one embodiment, caddies may be fitted in the storage container and removably attached to fixed attachments. Supplies and tools may be stored or attached in fixed or removable attachments.

In one embodiment, a housing at a bottom of the vertical member houses the rotatable apparatus. The rotatable apparatus comprises a rotatable and a spring. The spring surrounding the bottom section of the vertical member is installed in the housing which covers a rotatable and the bottom section of a vertical member. The spring mechanism in the rotatable apparatus acts as a brake to the rotatables to prevent the mobility aid task device from moving. Other braking mechanisms are also useful.

These and other advantages and features of the embodiments herein disclosed will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIGS. 1a-1h show an exemplary embodiment of mobility aid task device.

FIG. 2 shows the exploded view of an exemplary mobility aid task device.

FIGS. 3a-3c show exemplary uses of a mobility aid task device.

FIGS. 4a-4c show an exemplary brake system of the mobility aid task device.

FIGS. 5a-5c show exemplary storage components in a mobility aid task device.

FIGS. 6a-6c show exemplary uses of a mobility aid task device.

### DETAILED DESCRIPTION

Embodiments of the disclosure generally relate to mobility aid task devices having mobility aid, mobile storage and seat. The device provides support when performing tasks for people having physical limitations. Elderly and physically handicapped people have limitations in the movement of their backs, necks, arms, and legs. House tasks become a challenge, such as cleaning, gardening, house maintenance, and home repairs. The disclosed device may be used at home for elderly and physically limited people who desire to live at home and maintain independence. This device may also be used in assisted living facilities where the elderly and physically limited people may have autonomy in maintaining their living quarters.

The mobility aid task device may be made of plastic, acrylic, metal, alloy, cloth, fabric, wood, crystalline materials, a combination thereof, or other materials. The device is embodied in its concepts, not limited in its material compositions, shapes or forms. The device amalgamates the concepts of mobility aid, seating arrangement and easily accessible mobile storage. The mobility aid task device alleviates the problems of mobility difficulties. The seating arrangement provides bodily support and balance when performing tasks. The easily accessible mobile storage provides task related functions and ease of access to tools and supplies. Furthermore, the seating arrangement and the mobile storage are transported with the mobility aid to the desired task location.

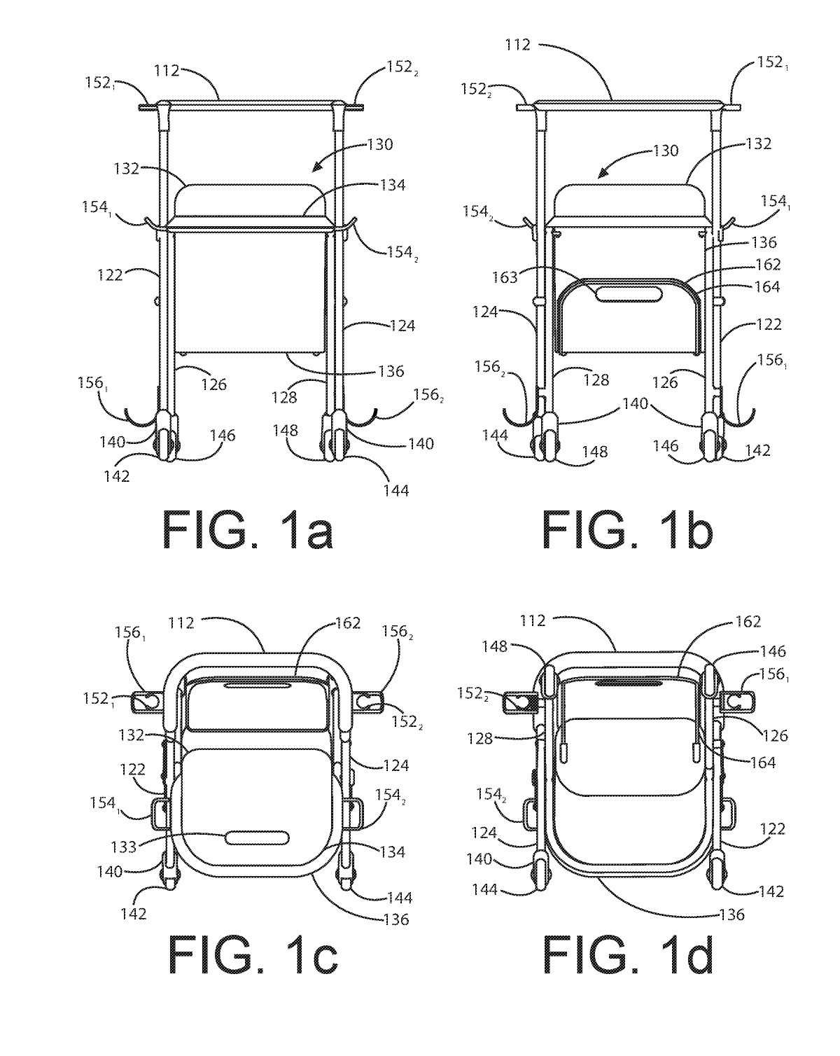

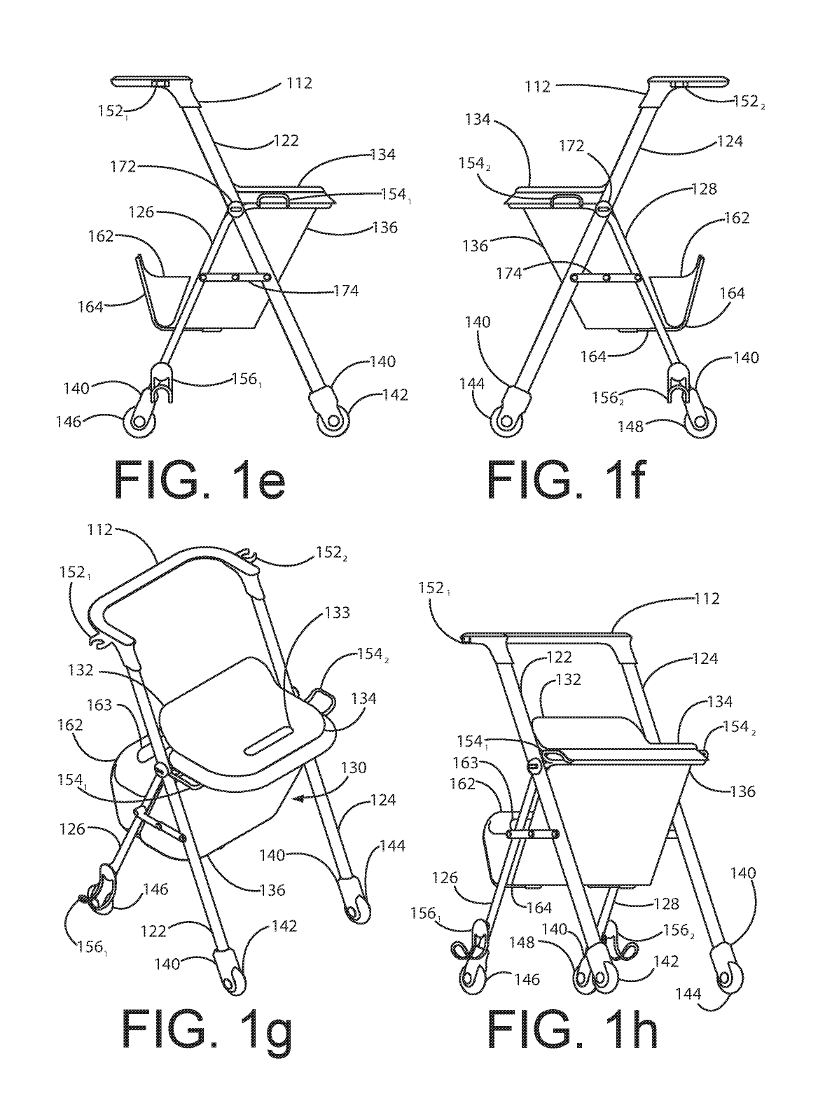

FIGS. 1a-1h show different views of an embodiment of mobility aid task device including front, back, top, bottom, right lateral, left lateral, and prospective views. The right-left direction of the device is the first direction; and the front-back direction is the second direction.

FIG. 1a shows the front view of the mobility aid task device including a main framework of a crosspiece, one or more front vertical members, one or more back vertical members, one or more mobile storage and a plurality of rotatables at the bottoms of vertical members. In one embodiment, the crosspiece may include a handle bar 112. A first mobile storage 130 may include a storage container 136, a storage cover 134 for seating and an optional back stop 132. The vertical members may include front right and left vertical members 122 & 124 and back right and left vertical members 126 & 128. Other embodiments may have one front and two back vertical members, or two front and one back vertical members. The vertical members coupled with the crosspiece constitute part of the main framework. The mobility aid task device may also include a support framework such as support rods and wire frames, etc.

Referring to FIG. 1a, in one embodiment, the crosspiece 112 is disposed, for example, on top of the device and may be slightly wider than the distance between the right and left members in a first direction (right-left direction). The crosspiece may be disposed at about an elbow height of an average adult. The crosspiece may also be disposed at a different height or have the same or narrower width than the distance between the right and left vertical members in the first direction.

The first mobile storage 130 includes a storage container 136, a storage cover 134, and an optional back stop 132. The storage container may be a tub storage container. The tub may be in a square, rectangular, or other regular or irregular shapes. The storage container may have different sizes and is generally disposed between the right and left vertical members. The storage cover is disposed in the storage container at a level about the average standing adult hip height on which an adult may sit with knees bending only slightly, for example, between ninety and one-hundred-eighty degrees. Vertical members may be lengthened for taller people, or shortened for shorter people (not shown). Foot rests may be installed at the bottom of the device to rest the user's legs when sitting (not shown). The storage cover may be fixed or removable on the storage container. The storage cover is generally opened from the front. Opening from the back is also useful. The back stop, when present, is generally disposed near the top surface of the storage cover toward the back of the storage container. The back stop delimits the back border of the flat surface of storage cover. The back stop helps guide the user sitting to the back border of the seat.

Continuing with FIG. 1a, the mobility aid task device includes attachments. Attachments may be fixed or removable on the top, side, or bottom of the mobility aid task device. Attachments serve various functions including, but not limited to, placing, hanging, and stabilizing supplies, tools, or other attachments. Exemplary attachments include, but are not limited to, top hooks, side hangers and bottom clips. The words “hooks”, “hangers”, and “clips” do not necessarily limit the size, shape, location, or the function of the attachments. In one embodiment, top hooks 152₁ & 152₂ are attached to the crosspiece, side hangers 154₁ & 154₂ to the support framework near the storage container, and bottom clips 156₁ & 156₂ to the vertical members at the bottom of the device. Other numbers or placements of attachments may also be useful.

As described, attachments may be fixed or removable. Fixed attachments may be affixed to the main framework or support framework. Removable attachments may refer to attachments used for performing tasks. For example, caddies may be attached to the side hangers or top hooks or bottom clips. The caddies are configured to removably fit in the storage container under the storage cover when not in use. The caddies may have hand slots for ease of carrying or attaching to fixed attachments. Removable attachments include, but are not limited to, trash bags, caddies, cleaning buckets, house task supplies and tools.

The mobility aid task device may also include housings 140. Rotatables at the bottom of the vertical members are covered by housings. In one embodiment, housings 140 enclose springs and house rotatables to make up the rotatable apparatus. The rotatable apparatus comprises springs and rotatables. The rotatable apparatus may be coupled to each vertical member by a spring mechanism installed in a housing at the bottom of the vertical member. In other embodiments, the rotatable apparatus may be installed with the springs attached on other portions of the mobility aid task device and connected to the rotatables. Springs installed in the housings prevent the device from skidding by a braking mechanism effected on the rotatables. For example, when a user initiates sitting or is on the seat, the user's weight pushes down on the springs. The braking mechanism of the rotatable apparatus is activated preventing rotatables from turning and the mobility aid task device stops moving. Other brake systems may also be useful.

FIG. 1b illustrates the back view of a mobility aid task device embodiment similar to that shown in FIG. 1a. Common elements are incorporated by reference and may not be described in detail. The mobility aid task device includes, but is not limited to, a crosspiece 112, one or more mobile storage, front right and left vertical members 122 & 124, back right and left vertical members 126 & 128, front right and left rotatables 142 & 144, and back right and left rotatables 146 & 148. The first mobile storage 130 shows storage container 136 and back stop 132. The rotatables are disposed at the bottom of the vertical members. The front vertical members and front rotatables may or may not be visible in the back view depending on the alignment of the front and back vertical members in the second direction (front-back direction).

The device also includes housings 140. Rotatables on the bottom of the vertical members are covered by housings. The housings enclose springs and house rotatables to make up the rotatable apparatus. The rotatable apparatus is coupled with each vertical member in a housing at the bottom of the vertical member. Attachments such as top hooks 152₁₋₂, side hangers 154₁₋₂, and bottom clips 156₁₋₂ are shown attached to the device. Removable attachments are also useful. The numbers, sizes, shapes, and locations of attachments may be varied as needed.

Continuing with FIG. 1b, the back view shows the posterior components of the embodiment. The storage container has an optional back stop. A support framework 164 made of support rods, wire frames, or a combination thereof is coupled with the first mobile storage 130 and the right and left vertical members 122-128. The support framework may also be coupled with the crosspiece. The vertical members are coupled with the crosspiece and support framework. The storage container may be coupled with the vertical members by support framework such as wire frames and support rods. A back bucket 162 may be referred to as a second mobile storage. The back bucket is removably disposed in the support framework 164. The back bucket has a cutout 163 on the top. The cutout may be wide enough for hand grasp, or small enough to hang on a nail or hook, or a combination thereof. The back bucket is in the back of the storage container.

FIG. 1c illustrates the top view of an embodiment of mobility aid task device. The mobility aid task device includes, but is not limited to, a crosspiece, one or more mobility storage, front right and left vertical members, back right and left vertical members, right and left rotatables. The rotatables include front 142 & 144 and back rotatables where the back rotatables may not be visible. The crosspiece 112, in one embodiment, is disposed in the posterior curving forward and coupled to the front right and left vertical members 122 & 124. The front right and left vertical members 122 & 124 are coupled with rotatables 142 & 144. The first mobile storage 130 is disposed generally between the vertical members in the first and second directions. The mobile storage container 130 includes storage container 136, storage cover 134, which serves as a seat, and optional back stop 132. The center of gravity of the first mobile storage with a seater therein is within the scope of vertical members. The storage cover has a finger slot 133 for hand or finger grip. The back stop on the storage cover provides a guide for the user to determine the back edge.

Attachments of top hooks 152₁₋₂, side hangers 154₁₋₂, and bottom clips 156₁₋₂ are shown on the right and left sides of the device. The attachments may be disposed in a right-left direction, front-back direction, or other directions. Although the top hooks 152 and bottom clips 156 may be in a vertical alignment, the attachments do not necessarily need to be aligned. The numbers and shapes of attachments may also be varied.

The top view also illustrates the back component of the embodiment of the device. A support framework 164 made of support rods and wire frames is coupled with one or more mobile storage, the right and left vertical members, the crosspiece, or a combination thereof. A back bucket 162 is removably disposed in the support framework 164. The back bucket has a slot 163 on the top. The slot may be wide enough for hand grasp, or small enough to hang on a nail or hook, or a combination thereof. The hand slot may be used for lifting the back bucket.

FIG. 1d shows the bottom view of an embodiment of the mobility aid task device. The mobility aid task device includes, but is not limited to, a crosspiece 112, first and second mobile storage 130 & 162, front right and left vertical members 122 & 124, back right and left vertical members 126 & 128, front right and left rotatables 142 & 144, and back right and left rotatables 146 & 148. The vertical members are coupled in the first and second directions by the crosspiece, main framework, and support framework. The support framework 164 made of support rods and wire frame is coupled with the first and second mobile storage 130 & 162 and front and back vertical members. The first mobile storage 130 is fixedly or removably coupled with the vertical members.

Rotatables 142-148 are connected with vertical members 122-128 in a housing 140 near the bottom of the vertical member. Back bucket 162 is removably disposed in the back of the mobility aid task device and supported by the support rods and wire frames of the support framework 164. Attachments of top hooks 152, side hangers 154 and bottom clips 156 are attached to the main or support framework.

FIG. 1e shows the right lateral view of mobility aid task device including, but not limited to, a crosspiece, front vertical members, back vertical members, a first and second mobile storage, and rotatables. The crosspiece, disposed on the top and near back portion of the mobility aid task device is coupled with the front vertical members.

The first mobile storage is coupled with the vertical members by the support framework such as wire frames and support rods installed in the front and back vertical members. The storage container of the first mobile storage is generally parallel to the back vertical members. The storage container may also be in configurations other than parallel to the back vertical members. The storage container has the center of gravity within the vertical members. The storage container provides storage space for the placement of the removable caddies, supplies and tools. The storage cover is generally parallel to the ground providing seating at a level about standing average adult hips where an adult may sit with knees bending only slightly, for example, between ninety and one-hundred-eighty degrees. Vertical members may be lengthened for taller people, or shortened for shorter people (not shown). Foot rests may be installed at the bottom of the device to rest the user's legs when sitting (not shown). The user seating is within the center of gravity of the mobility aid task device for stability.

The front and the back vertical members of the same side are connected in the second direction by rotatable and collapsible hinges. A rotatable hinge 172 allows the front vertical member and back vertical member to pivot at the hinge and fold upon each other. A collapsible hinge 174 has two side arms connecting to the front vertical member and the back vertical member by rotatable hinges. For example, three rotatable hinges connect the front and back vertical members with two side arms to form a collapsible hinge. The two side arms extend and stop at a horizontal position when the mobility aid task device is in use. Rotatable hinges allow the two side arms to fold toward each other when the mobility aid task device is not in use. The hinges allow the vertical members to fold upon each other and close the device to a collapsed position for storage. Other configurations of rotatable and collapsible hinges are also useful.

The front and back left rotatables 142 & 146 are disposed in housings installed at the bottom of the right vertical member members 122 & 126. The housing encloses a spring and a rotatable and is coupled between the rotatable and the vertical member. The spring provides the brake mechanism of the device. When a weight is applied to the mobility aid task device, such as cleaning supplies on the device or user's body weight on the seat, the weight is transmitted to the spring. The spring compresses and the vertical member presses on the rotatable preventing the rotatable from turning, which stops the mobility aid task device from moving.

The back bucket 162, disposed in the back of the mobility aid task device, may be supported by the support framework 164. The support framework is coupled with the main framework by support rods and/or wire frames. The back bucket is removable from the support framework for use. The crosspiece has top hooks for removable attachments. The side hangers may be installed in the wire frames next to the seat of the storage container for removable attachments. The bottom clips are installed near the bottom of the vertical members for removable attachments and support of cleaning tools.

FIG. 1f shows the left view of mobility aid task device including, but not limited to, a crosspiece, front vertical members, back vertical members, a mobility storage, a back bucket, and rotatables. The crosspiece, disposed on the top and near back portion of the mobility aid task device is coupled with the front vertical members.

The mobility storage is coupled with the vertical members by the support framework such as wire frames and support rods installed in the front and back vertical members. The storage container of the mobility storage is generally parallel to the back vertical members. The storage container may also be in configurations other than parallel to the back vertical members. The storage container has the center of gravity within the vertical members. The storage container provides storage space for the placement of the removable caddies and cleaning supplies. The storage cover is generally parallel to the ground providing seating at a level about standing average adult hips where an adult may sit with knees bending only slightly, for example, between ninety and one-hundred-eighty degrees. Vertical members may be lengthened for taller people, or shortened for shorter people (not shown). Foot rests may be installed at the bottom of the device to rest the user's legs when sitting (not shown). The user seating is within the center of gravity of the mobility aid task device for stability.

The front and the back vertical members of the same side are connected in the second direction by rotatable and collapsible hinges. A rotatable hinge 172 allows the front vertical member and back vertical member to pivot at the hinge and fold upon each other. A collapsible hinge 174 has two side arms connecting to the front vertical member and the back vertical member by rotatable hinges. For example, three rotatable hinges connect the front and back vertical members with two side arms to form a collapsible hinge. The two side arms extend and stop at a horizontal position when the mobility aid task device is in use. Rotatable hinges allow the two side arms to fold toward each other when the mobility aid task device is not in use. The hinges allow the vertical members to fold upon each other and close the device to a collapsed position for storage. Other configurations of rotatable and collapsible hinges are also useful.

The front and back left rotatables 144 & 148 are disposed in housings installed at the bottom of the left vertical member members 124 & 128. The housing encloses a spring and a rotatable and is coupled between the rotatable and the vertical member. The spring provides the brake mechanism of the device. When a weight is applied to the mobility aid task device, such as cleaning supplies on the device or user's body weight on the seat, the weight is transmitted to the spring. The spring compresses and the vertical member presses on the rotatable preventing the rotatable from turning, which stops the mobility aid task device from moving.

FIG. 1g shows a perspective top view of the mobility aid task device. The device comprises a crosspiece 112, front right and left vertical members 122 &124, back right and left vertical members 126 & 128 (not shown), a first and second mobile storage 130 & 162, front right and left rotatables 142 & 144 and back right and left rotatables 146 & 148 (not shown). The first mobile storage 130 includes storage container 136, storage cover 134 as a seat, and an optional back stop 132. The crosspiece, disposed in the back of the device, is in a U shape and connects to the right and left front vertical members. A front vertical member is connected to a back vertical member on the same side in the second direction by rotatable and collapsible hinges. The rotatable hinge allows the front member and back member to pivot at the hinge and fold upon each other. The collapsible hinge has two side arms connecting the front member and the back member by rotatable hinges. When extended, the collapsible hinge provides support and strength for the vertical members and the device. When collapsed, the collapsible hinge allows the vertical members to fold upon each other for storage of the device. A rotatable apparatus is coupled with a vertical member including a spring and a rotatable enclosed in a housing installed at the bottom of the vertical member. The rotatable apparatus allows the mobility aid task device to be moved in a desirable direction.

FIG. 1h shows the prospective lateral view of the mobility aid task device. Common elements as those in FIG. 1g are incorporated by reference and may not be described in detail. In one embodiment, the mobility aid task device includes, but is not limited to, a crosspiece, a storage container, front right and left vertical members 122 & 124, back right and left vertical members 126 & 128, front right and left rotatables 142 & 144 and back right and left rotatables 146 & 148. The rotatables are disposed at the bottom of the vertical members. The crosspiece may include a handle bar 112. The first mobile storage 130 may include a flat surface 134 for seating. The right and left vertical members are coupled by the crosspiece, storage container, and support framework including wire frames and support rods. The right-left direction of the device is the first direction; and the front-back direction is the second direction.

Referring to FIGS. 1g-1h, the crosspiece 112 is disposed on top of the device slightly wider than the right and left vertical members in a first direction (right-left direction). The crosspiece may also be the same or narrower than the right and left vertical members in a first direction. The crosspiece is generally disposed at about an elbow height of an average adult. The crosspiece may also be disposed at a different height.

The storage container includes a flat top surface 136, a storage cover 134, and an optional back stop 132. The storage container may be a tub storage container. The tub may be in a square, rectangular, or other shape. The storage container may have different sizes and is generally disposed between the right and left vertical members. The storage cover 134 is disposed in the storage container at a level about standing average adult hips on which an adult may sit with knees bending only slightly, for example, between ninety and one-hundred-eighty degrees. Vertical members may be lengthened to elevate the seat height for taller people, or shortened for shorter people (not shown). Foot rests may be installed at the bottom of the device to support legs when sitting (not shown). The storage cover may be fixed to, or removable from, the storage container. The storage cover is generally openable from the front. Opening from the back is also useful. The back stop, when present, is generally disposed near the flat top surface toward the back of the storage container. The back stop delimits the back border of the flat surface. The back stop helps guide the user sitting to the back border of the seat.

The mobility aid task device includes rotatables. Rotatables are disposed at the bottom of vertical members and covered by housings 140. Rotatables provide transport movement for the mobility aid task device. A rotatable apparatus is coupled with a vertical member including a spring mechanism installed in a housing at the bottom of the vertical member. Springs installed in the housings prevent the device from skidding by braking the rotatables. When a user initiates sitting or is in the seat, the user's weight pushes down on the springs which activates the braking mechanism of the rotatable apparatus. Rotatables allow the movement of the device to a desirable location. Rotatable apparatus system brakes the rotatables and prevents the device from skidding.

Continuing with FIGS. 1g-1h, the mobility aid task device includes fixed and removable attachments. Attachments serve various functions including, but not limited to, placing, hanging, and stabilizing instruments or other attachments. Exemplary attachments include, but are not limited to, top hooks, side hangers and bottom clips. The words “hooks”, “hangers”, and “clips” do not necessarily limit the sizes, shapes, locations, or the functions of the attachments. In one embodiment, top hooks 152₁ & 152₂ are attached to the crosspiece. Side hangers 154₁ & 154₂ are attached to a support framework coupled with the right and left vertical members. Bottom clips 156₁ & 156₂ are attached to the back right and left vertical members at the bottom of the device. The top hooks, side hangers, and bottom clips may have different shapes, sizes, quantities, and locations in the device. Other numbers or placements of attachments may also be useful.

Removable attachments are also contemplated. Removable attachments include, but are not limited to, trash bags, caddies, cleaning buckets, house task supplies and tools. Removable attachments may be attached to a fixed attachment, main framework or support framework. For example, trash bags may be attached to the top hooks; long cleaning tools may be attached to the top hooks and bottom clips; and caddies may be attached to the side hangers. The caddies, in one embodiment, are configured to fit in the storage container under the storage cover. The caddies may have handles for the ease of carrying or attaching to fixed attachments. A back bucket 162 may be referred to as a second mobile storage. A back bucket 162, installed in the back of the mobility aid task device, is removable and supported by support framework, such as support rods and wire frames. The back bucket has a hand slot 163 for hand grasp and lifting from the support framework. The back bucket allows placement of wet cleaning tools and cleaning water or waste water. The bottom and sides of the back bucket may have triangular, square, round, rectangular, polygonal, regular, or irregular shapes. Other shapes and configurations may also be useful.

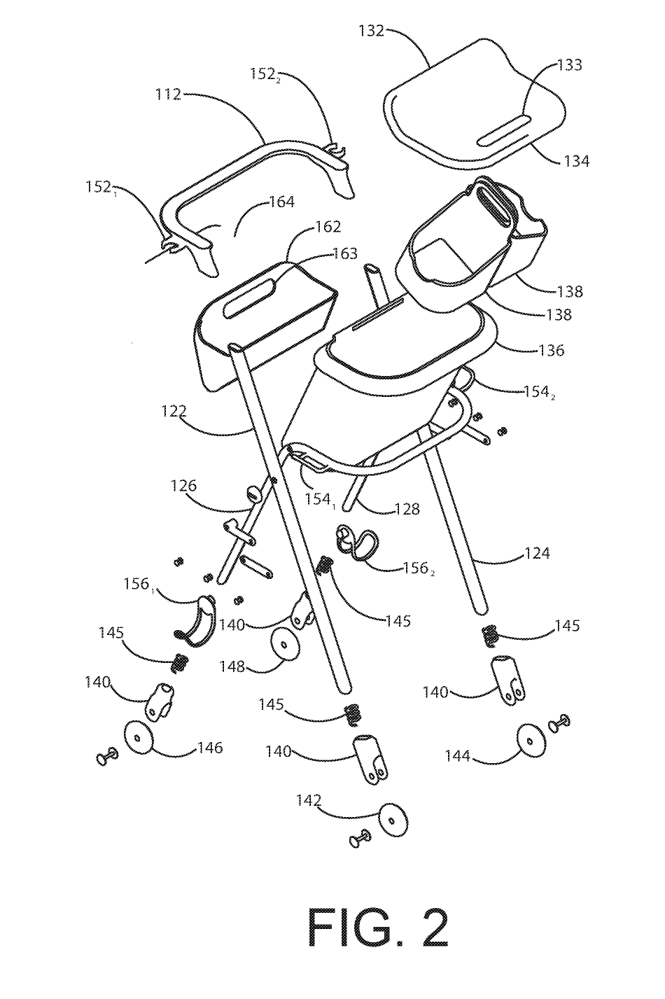

FIG. 2 shows the exploded view of an exemplary mobility aid task device. The mobility aid task device is similar to the device described in FIGS. 1a-1h. Common elements are incorporated by reference and are not described or described in detail. A crosspiece, in a U shape, is disposed in the back of the mobility aid task device and connects the front right and left vertical members. A molded softer material may be used to cover the crosspiece 112 for ease of push and control of the mobility aid task device. A front vertical member is connected to back vertical member of the same side in the second direction though rotatable and collapsible hinges. The rotatable hinge allows the front and vertical members to fold in the second direction. The collapsible hinge comprises two horizontal pieces connected through rotatable hinges. When collapsed, the collapsible hinge allows the front and back vertical members to fold for storage of the device. When extended, the collapsible hinges provide additional strength and stability of the mobility aid task device.

Continuing with FIG. 2, a plurality of caddies 138 having hand holders may be removably placed in the storage container. The caddies may store house task supplies and tools in the storage container. During house tasks, caddies may be removed from the storage container and placed on the side hangers for ease of access. The storage cover, installed on top of the storage container, provides a seat for the user. The storage cover may be fixed or removable and generally parallel to the ground. The storage container has an optional back stop as a safety stop for the user when sitting on the storage cover. The storage cover has a finger slot for lifting the cover to retrieve items from the storage container. The finger slot may also be used to remove the storage cover if the storage cover is removable.

The storage container of the first mobile storage is generally parallel in a substantially vertical direction to the back vertical members. The storage container may also be in a direction not parallel to the back vertical members. When the front and back vertical members are folded together, the long axis of the mobility aid task device is generally parallel to the long axis of the storage container. The back bucket, a second mobile storage disposed behind the first mobile storage, has a hand slot for ease of removal of the back bucket from the mobility aid task device. Wire frames may be installed on the front and back vertical members to support the storage container and the back bucket. Seat support rod or wire frame may be an extension of the vertical members and may support the storage container. Other support configurations may also be useful. Side hangers disposed in the storage container support framework, top hooks disposed in the crosspiece and bottom clips disposed in the vertical members may be referred to as fixed attachments. Fixed attachments may be used for removable attachments such as caddies, supply bags, trash bags, cleaning or task tools. Other types, shapes, and locations of attachments are also useful.

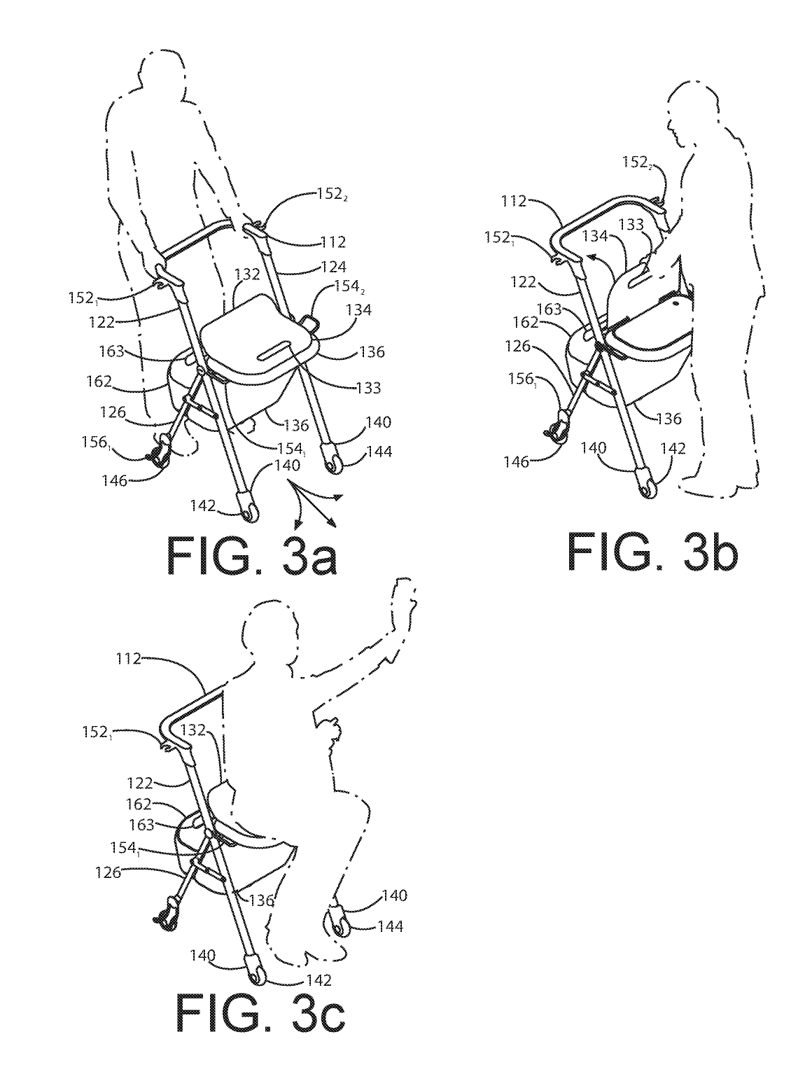

FIGS. 3a-3c illustrate exemplary uses of the mobility aid task device. FIG. 3a shows a user pushing or pulling the mobility aid task device by the crosspiece while using the device as a mobility aid for balance, or transport. Mobility aid task device supports the user like a walker and carries supplies or task tools like a cart. Supplies and task tools may be stored in the storage container 136 and the back bucket 162, or attached to the top hooks 152, side hangers 154 and bottom clips 156. The supplies and task tools may be transported by pushing or pulling the mobility aid task device.

In FIG. 3b, the storage cover on the storage container may be lifted by the finger slot. Supplies or task tools may be stored inside the storage container. A front user can view the contents inside the storage container without bending over because the slanted angle of the storage container is generally parallel to the line of vision. One or more caddies may be fitted inside the storage container (not shown). Caddies may have different shapes, sizes and be equipped with handles to be lifted from the storage container. A long cleaning tool may be placed in the back bucket 162 (not shown) and moved along with the mobility aid task device.

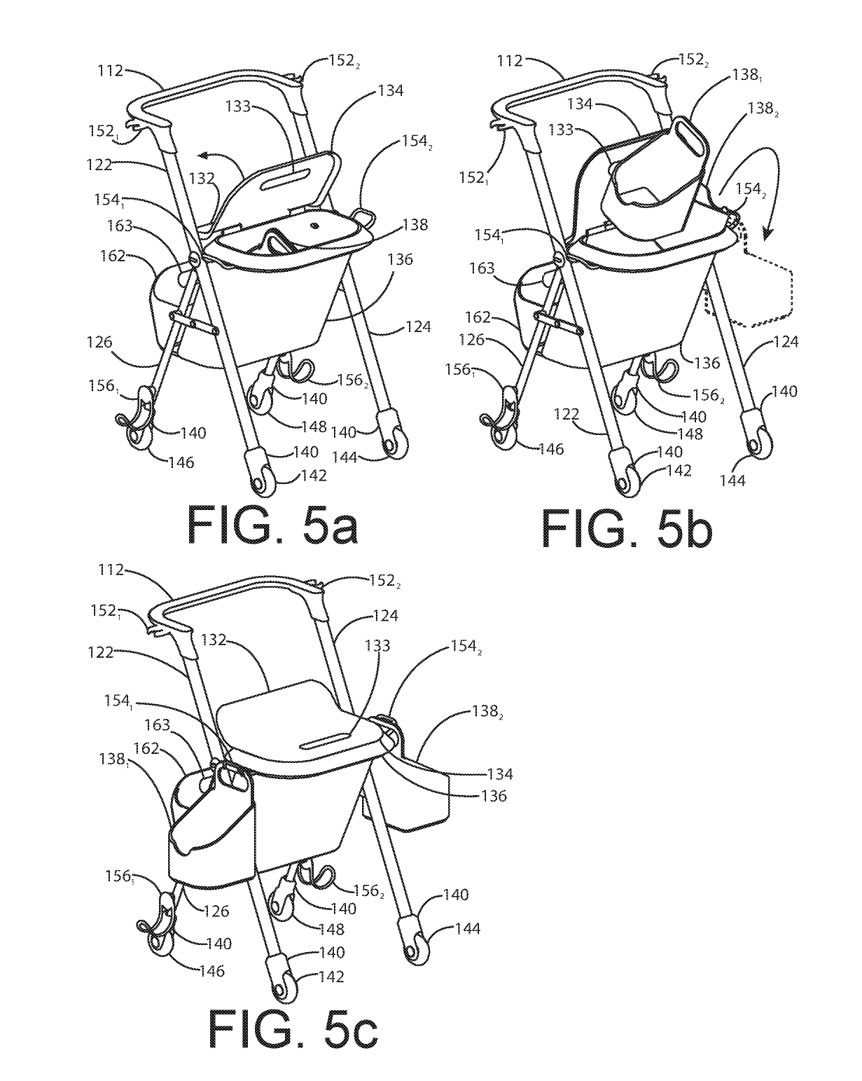

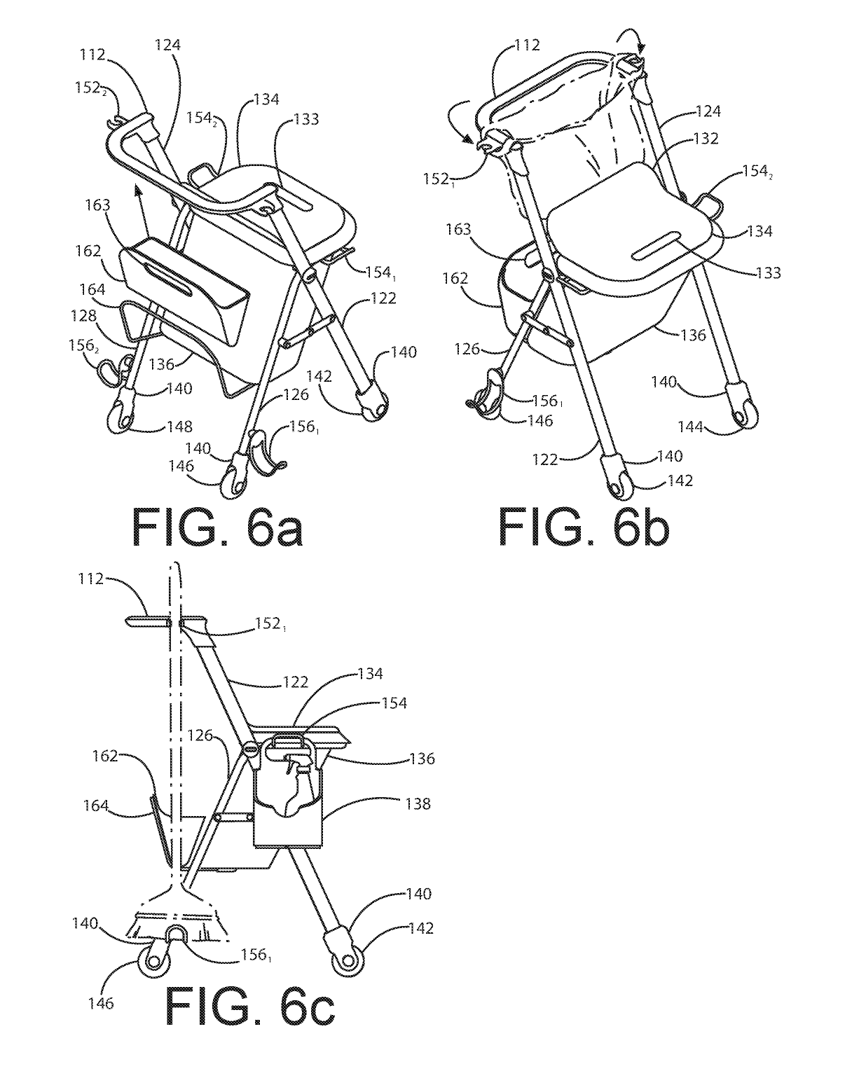

FIG. 3c shows a user using the mobility aid task device as a seat by sitting on the storage cover. The seat (storage cover) is generally at a level about standing average adult hips. A user may sit with knees bending, for example, generally between ninety and one-hundred-eighty degrees. Vertical members may be lengthened for taller people, or shortened for shorter people (not shown). Foot rests may be installed at the bottom of the device to rest the user's legs when sitting (not shown). Other height adjustment methods and knee bending degrees may also be useful. The seat is disposed within the center of gravity of the mobility aid task device. The user may sit on the seat while performing cleaning or house tasks. The storage cover has an optional back stop which serves as a safety stop in seating. A caddie may be removed from the storage container and removably attached to the side hanger 154 (shown in FIG. 5c). Cleaning bottle and supplies may be placed in the caddie on the side of the user (shown in FIG. 6c). A user can reach for cleaning supplies and tools while sitting in the seat. The storage container, disposed in an angle away from the knees and legs of the user, leaves room for the maneuvering of the knees and legs.

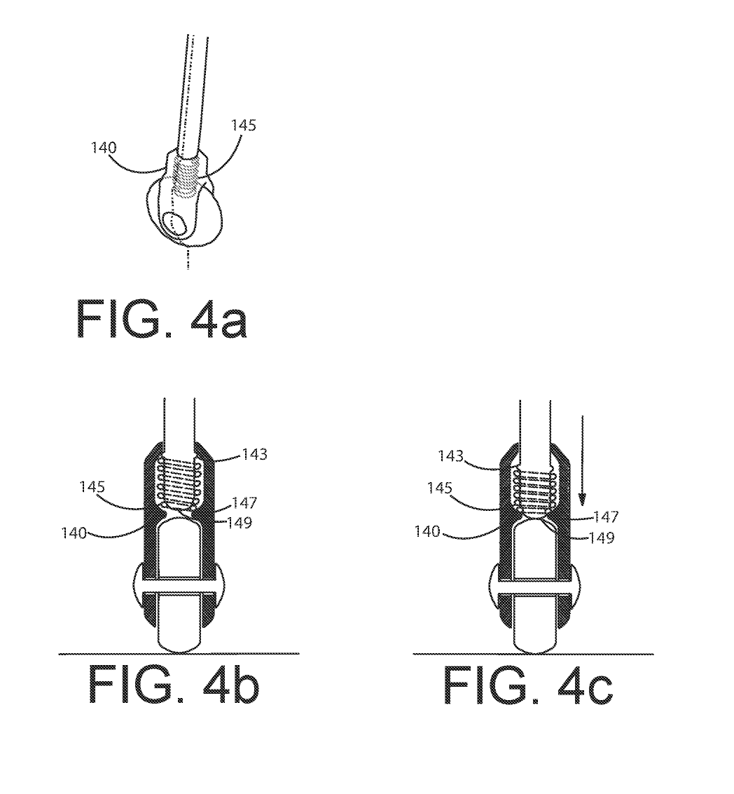

FIGS. 4a-4c show enlarged views of an exemplary embodiment of brake system of the mobility aid task device. In one embodiment shown in FIG. 4a, a housing encloses rotatable apparatus including a spring and a rotatable. The rotatable apparatus works as part of a brake system. The spring 145 is installed within the housing 140 disposed between a rotatable and a vertical member. The spring is fully extended when not activated. The spring is depressed when a pressure such as body weight or downward force is applied on the mobility aid task device. The depressed spring allows the vertical member to touch the rotatable (shown in FIG. 4c). The friction prevents the rotatable from turning and the mobility aid task device stops moving. A user may sit in the seat reaching for supplies and tools with the stability provided by the brake system. The example is shown on one rotatable apparatus system. This similar mechanism may be used for more than one or all rotatable apparatus systems.

FIG. 4b shows the exemplary braking system in the first directional view. As shown, a coil spring 145 is housed within the housing 140. The housing includes an upper portion and a lower portion. The two portions are divided on periphery by a periphery divider 147, but open in the central portion. The upper portion encloses a coil spring 145 and the lower portion houses a rotatable. The vertical member has protrusions 143 near the level of the top edge of the upper portion. A coil spring is fitted between the protrusions 143 and the periphery divider 147. The coil spring expands fully top and bottom between the protrusions and the periphery divider. The relatively round protrusion 149 at the bottom of the vertical member is not touching the rotatable.

FIG. 4c shows the exemplary braking system activated in the first direction. A generally downward force on a vertical member is produced when a force is applied on the mobility aid task device. A force may be produced by multiple modes, for example, a user sitting on the seat, a user pushing down on the crosspiece, a hand pushing down on the seat, or a weighted tool placed on the seat or in a fixed or removable attachment. The downward force pushes the vertical member toward the open space near the housing divider while the coil spring is being compressed. The vertical member has a relatively round protruded portion 149 on the bottom. The relatively round protruded portion 149 touches the rotatable 140. The friction stops the rotatable from turning; and the mobility aid task device stops moving. When the downward force is removed, the coil spring expands to the original length by pushing against the protrusions 143 of the vertical member. The vertical member moves upward leaving the rotatable and releases the brake. The rotatable is free from friction and turnable; and the mobility aid task device is again movable.

In other embodiments, the mobility aid task device may have other brake systems. For example, in one embodiment, floor locks are mounted to the underside of the housing. A user may step on the floor lock pressing on the rotatables to prevent the mobility aid from moving. In another embodiment, a cable on the crosspiece may be connected to the rotatables and is pulled to activate the brake system. In another embodiment, bottom pads with a suction-cup surface may be mounted on the underside of the housings. When a user sits on the storage container, the weight pushes down on the device that the suction cup makes contact with the ground and stop the device from moving. The mobility aid task device may have a brake system as described above or a combined system thereof. Other brake systems are also useful.

FIGS. 5a-5c show exemplary combinations of the mobility aid task device components. The mobility aid task device provides a plurality of mobile storage. Mobile storage is storage on a mobility aid, including, but not limited to, storage container (first mobile storage), back bucket (second mobile storage), caddies, fixed and removable attachments. FIG. 5a shows the view of the storage container 136 with the storage cover 134 lifted. One or more caddies 138 with handles may be fitted inside the storage container. Caddies 138 may be removed from the storage container and hung on the side hangers 154, which are accessible to the user sitting in the seat. A back bucket 162, partially visible, is disposed behind the storage container. Back bucket has one or more handles where the user can lift the back bucket to add cleaning liquid or remove waste water. Wet cleaning tools such as mops or squeegees may be placed in the back bucket. Alternatively, dry tools may be placed in the back bucket.

FIG. 5b, in one embodiment, shows the configuration of the caddies removed from the storage container. Caddies 138 have handles and may be removably attached by the handles on the side hangers 154. The emptied central container may be used for additional receptacle. The top hooks 152, disposed on the crosspiece, and bottom clips 156, disposed on the back vertical members are behind the removably attached caddies. This configuration provides additional attachment mechanisms without crowding or interference from the caddies.

FIG. 5c, in one embodiment, shows the caddies on the side hangers and the storage cover of the storage container in a closed position. The caddies and back bucket may carry supplies or task tools in plain sight while the storage container may carry materials in hidden sight. The storage cover may also be used for temporary placement of materials or tools. The mobility aid task device may be pushed or pulled to a desired location as a mobile storage unit.

FIGS. 6a-6c show exemplary placements of tools in an embodiment of mobility aid task device. Referring to FIG. 6a, the back bucket 162 may provide a container for liquid. Wet cleaning tools such as drippy mops, wet tools, or squeegees may be placed in the wet back bucket. The back bucket has one or more hand slots and is removable from the support frame to dump out dirty water or refill clean water. Edges near the top of the back bucket may be slightly curved-in to contain the liquid or for scraping the cleaning tools (not shown). When made of clear plastic, the back bucket allows visual inspections from a distance of the cleaning liquid. When used in dry condition, the back bucket may accommodate dust pans, trash bags, feather dusters, paper towels and other dry cleaning supplies or task tools.

FIG. 6b shows an exemplary use of top hooks. Research shows common problems of lacking trash bag accessibility i.e., the placement of trash bags, during the cleaning and house tasks. For example, some cleaning crew use door knobs to hang trash bags or place them on the floor. The trash bags are difficult to keep open and have to be moved constantly during the cleaning. The top hooks provide a convenient place to hold trash bags and keep them open to receive trash. The trash bags may be collected and replaced with fresh ones. The trash bags are accessible to the user at task locations by moving the mobility aid task device with the user. Additionally, the trash bag is placed behind the seat and will not interfere with the seating. A user may also sit sideways on the seat and reach the trash bags on the user's side. In addition to trash bags, the top hooks may hold other bags, baskets, or task tools.

FIG. 6c shows additional exemplary uses of fixed and removable attachments in the mobility aid task device. As shown, the top hook 152 may hold the top portion of a long cleaning or task tool such as a broom. The bottom of the tool rests in the bottom clip 156 of the same side. The two points support of a long cumbersome cleaning or task tool stabilize the tool. This feature makes it easier and safer for the user to move the mobility aid task device. The bottom clips may be made to slide to the back and hold a relatively long tool in the first direction (not show) under the back bucket. In another example, caddies 138 may be easily accessible on the user's sides when cleaning in a sitting position. The slanted top contour of the caddie makes the retrieval easier on the rigid wrists, arms and elbows. This would be helpful for the elderly who tend to have limited range of motions caused by age, arthritis, and other physical conditions. Caddies may accommodate cleaning bottles or task tools in an upright position. The caddies may also accommodate cleaning or task supplies such as sponges, paper towels, cleaning cloth, cleaning brushes, hammers, nails, and repair adhesives etc. A dust pan may be rested in the back bucket for accessibility. Collected dust may be dumped into the back bucket for temporary deposit or a trash bag hung on the top hooks as described above. Top hooks 152, side hangers 154, and bottom clips 156 may have unilateral or bilateral placements. A user may use one side or both sides. The various combinations of the placement of the removable attachments make it possible for a user to sit facing forward or sit facing one side or the other.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A device comprising:
a mobility aid having a plurality of vertical members wherein a rotatable is coupled at a bottom of the vertical member wherein a spring is disposed in a rotatable apparatus which brakes the rotatable by having the vertical member touch the rotatable;
one or more mobile storages disposed in the mobility aid; and
a seat disposed in a first mobile storage at an adult hip height level.

2. The device of claim 1 wherein the mobility aid further comprising:
a crosspiece disposed in a first direction wherein the vertical members are disposed in a second direction including one or more front vertical members and one or more back vertical members wherein the front or the back vertical members are coupled with the crosspiece.

3. The device of claim 1, wherein the first mobile storage comprising:
a storage container; and
a storage cover disposed in the storage container generally parallel to a ground.

4. The device of claim 3, wherein the storage cover serves as the seat at the adult hip height level.

5. The device of claim 3, further comprising:
a plurality of caddies removably fitted in the storage container.

6. The device of claim 2 further comprising a plurality of attachments including one or more top attachments, one or more side attachments, and one or more bottom attachments.

7. The device of claim 6, wherein the side attachments support caddies.

8. The device of claim 6 wherein the top attachments support receptacles.

9. The device of claim 6 wherein the top and bottom attachments support long tools.

10. The device of claim 1 comprising a second mobile storage including a back bucket.

11. The device of claim 1, wherein the spring is compressed by a weight to brake the rotatable.

12. The device of claim 2 wherein the mobility aid further comprising a support framework including wire frames and support rods.

13. A method of forming a mobility aid task device comprising:
forming a crosspiece in a first direction;
forming a plurality of vertical members in a second direction including one or more front vertical members and one or more back vertical members wherein the front or the back vertical members are coupled with the crosspiece;
forming one or more mobile storages coupled with the vertical members wherein a first mobile storage comprises a seat at an adult hip height level;
forming a plurality of rotatables wherein the rotatable is coupled at a bottom of the vertical member wherein a spring is disposed in a rotatable apparatus which brakes the rotatable by having the vertical member touch the rotatable; and
forming a plurality of fixed and removable attachments.

14. The method of claim 13 wherein the spring brakes the rotatable by applying a weight on the mobility aid task device.

15. The device of claim 1, wherein the mobility aid task device comprises plastic and metal.

16. A mobility aid task device comprising:
a crosspiece disposed in a first direction;
a plurality of vertical members disposed in a second direction including one or more front vertical members and one or more back vertical members wherein the front or the back vertical members are coupled with the crosspiece;
a plurality of rotatables wherein the rotatable is coupled at a bottom of the vertical member wherein a spring is disposed in a rotatable apparatus which brakes the rotatable by having the vertical member touch the rotatable; and
a mobile storage coupled with the vertical members including a storage container and a storage cover serving as a seat at an adult hip height level.

17. The device of claim 16, further comprising:
a support framework including a plurality of wire frames and support rods coupled with the vertical members; and
a plurality of attachments coupled with the support framework including
one or more top attachments,
one or more side attachments, and
one or more bottom attachments.

18. The device of claim 17, further comprising:
one or more caddies removably fitted in the storage container.

19. The device of claim 18, wherein the caddies are removably attached to the side attachments.

20. The device of claim 16, wherein the spring brakes the rotatable by applying a weight on the mobility aid task device.
